(19) United States
(12) Patent Application Publication
(10) Pub. No.: US 2008/0184200 A1
(43) Pub. Date: Jul. 31, 2008

(54) SOFTWARE CONFIGURATION POLICIES' VALIDATION, DISTRIBUTION, AND ENACTMENT

(75) Inventors: Steven Patterson Burns, Redmond, WA (US); Derek Menzies, Sammamish, WA (US); Mazhar Naveed Mohammed, Sammamish, WA (US); John Hayden Wilson, Woodinville, WA (US); Rahul Gupta, Bellevue, WA (US); Ullattil Shaji, Sammamish, WA (US); Rajive Kumar, Sammamish, WA (US)

Correspondence Address: SENNIGER POWERS LLP (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/627,865

(22) Filed: Jan. 26, 2007

(51) Int. Cl. G06F 9/44

(52) U.S. Cl. 717/121

(57) ABSTRACT

Managing software states using policy rules in a policy document in a distributed network. A policy document is generated and the policy document includes a set of policy rules defining one or more desired configurations of one or more pieces of software on the target devices. Target information is associated with the policy document, and the target information corresponds to a selected set of the target devices and includes information relating to characteristics of the software of the selected set of target devices. The set of policy rules included in the policy document is compared with other policy rules for the software. The policy document is modified as a function of the comparison and conflict resolution preferences. The modified policy document is provided for deployment to the selected set of the target devices.

### BACKGROUND

In a distributed computing network, software is installed on devices connected in the network. As users become familiar with the software running on their computers, they often alter the configuration of software to personalize it, secure it, etc. For example, a user may wish to change the appearances of the graphical user interface (GUI) for particular software, while another user may wish to set a specific timer for the screen saver program. A third user may wish to configure the media player appearance mode by hiding the media player toolbar and so forth.

While software may be personalized or customized to suit each user's taste or preference, network administrators typically wish to configure all software installed on each of the devices in the network with identical or uniform configurations. A uniform configuration not only makes deployment of the software more convenient, it also makes troubleshooting and maintenance tasks easier.

Typically, network administrators, information technology (IT) managers, and the like (collectively referred to as “IT management”) create a management policy that includes the intention and the goal of the IT management. Each individual device or system is responsible for regulating itself to comply with the policy. Currently, the IT management may create a policy rule, such as activating the screen saver program after a computer is idle for fifteen minutes, to be deployed to the computer. The IT management may place the policy in a policy authority, of which some embodiments may refer to as a server, and the policy authority periodically broadcasts a notification to the computer indicating a policy is to be received. The computer would need to be in an active connection with the policy authority for the policy to be executed on the computer.

In another practice, the policy authority may notify a listening component of the computer indicating that a policy is to be downloaded. Once an active connection is made with the policy authority, the computer downloads the policy and saves the policy in a memory area of the computer to be executed with or without having an active connection with the policy authority.

While these practices have been sufficient for performing certain tasks such as deployment of policies managing the software configuration, there are drawbacks. For example, some of the devices to be managed in the network may be complex and may need a customized format or syntax for the policy expression or rules. Therefore, a special set of policies may be required.

Another shortfall includes that, after the policy is deployed, the IT management lacks the ability to determine whether similar policies for the same target device create a conflict. For example, suppose an IT management staff A creates a policy for configuring the screen saver program to be activated after 15 minutes while, at the same time, another IT management staff B attempts to create a different policy for 20 minutes for the screen saver activation time. At the time of deployment, the IT management staff A would not know there might be a conflict with the different policy created by the IT management staff B. For the target device, the software would just adopt the policy from both and keeps on changing the configuration. Alternatively, a hardcoded rule, such as based on the time when the rules are received, may choose that the policy created by the IT management staff A overrides the policy by the IT management staff B.

Additionally, existing policies are imperative in which each of the policies are a set of instructions that the target devices of the policies is supposed to execute. The existing policy deployment framework also lacks a feedback loop wherein the target device of a policy can report its compliance with that policy to the policy authority or the IT management staff.

### SUMMARY

Embodiments of the invention overcome deficiencies of existing systems or practices by defining a schema for policy rules or executable expressions for managing software configuration. Embodiments of the invention further establish conflict detection of conflict policy rules before the rules are deployed to the target devices. In addition, aspects of the invention further receive responses from each of the target devices indicating the status or state of the software after the policy rules are applied.

In addition, aspects of the invention provide a declarative paradigm in the policy implementation in which each of the policies, having schemas associated therewith, describes the valid end state of the target devices, and the target devices decide how to reach that state. This declarative feature at least enables the means by which the desired end-state is reached to evolve over time without need of changing the expression of the policy, and enables expressing the policies in a form that is more readily machine-processed so as to enhance the conflict detection/resolution capability. Furthermore, aspects of the invention provide a feedback loop for the target devices to report their compliance with that policy to the policy authority. Moreover, embodiments of the invention enhance extensibility of deployment of policy documents by employing a proxy server may perform tasks, such as policy requesting, for the target devices.

According to alternative aspects of the invention, schemas or document formats define uniform or standard relationships between objects and/or rules for configuring software configuration and/or settings and/or states. Embodiments of the invention also enhance representation of software states before the policy documents are applied.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating an exemplary embodiment of a system for managing policy rules for software installed on target devices in a distributed computer network according to an embodiment of the invention.

FIG. 2 is a block diagram illustrating exemplary components for applying policy rules to software on a target device according to an embodiment of the invention.

FIG. 3 is an exemplary graphical screen shot illustrating a policy generation user interface according to an embodiment of the invention.

FIG. 4 is an exemplary flow chart illustrating operation of managing policy rules for software installed on target devices according to an embodiment of the invention.

FIG. 5A is an exemplary XML policy document generated according to an embodiment of the invention.

FIG. 5B is an exemplary document generated on a managed target device as part of the application of policies on the target device according to an embodiment of the invention.

Appendix A illustrates an exemplary definition for data types applicable in embodiments of the invention.

Appendix B illustrates an exemplary list of operators on scalar types used in the policy rules definition appearing in the policy document according to an embodiment of the invention.

Appendix C illustrates one or more exemplary operators on aggregate types used in the definition of policy rules according to an embodiment of the invention.

Appendix D illustrates an exemplary set of action types to be used in a policy document according to an embodiment of the invention.

Corresponding reference characters indicate corresponding parts throughout the drawings.

### DETAILED DESCRIPTION

Embodiments of the invention establish a platform for efficient management of configurations and states of software installed on one or more target devices available throughout a computer network. Rather than limiting policy applications to patches or to just data stored in a specific location as with current technologies, embodiments of the invention provide a common platform or schema to apply the policies throughout the networked environment. Thus, many disparate and non-cooperating systems are no longer needed to provide a comprehensive management-by-policy solution. Furthermore, aspects of the invention provide conflict resolution and/or detection capabilities to resolve conflicts between rules in a policy document and permit adequate report or feedback from the target devices with respect to the status or state of the target devices before and after the policy rules are applied.

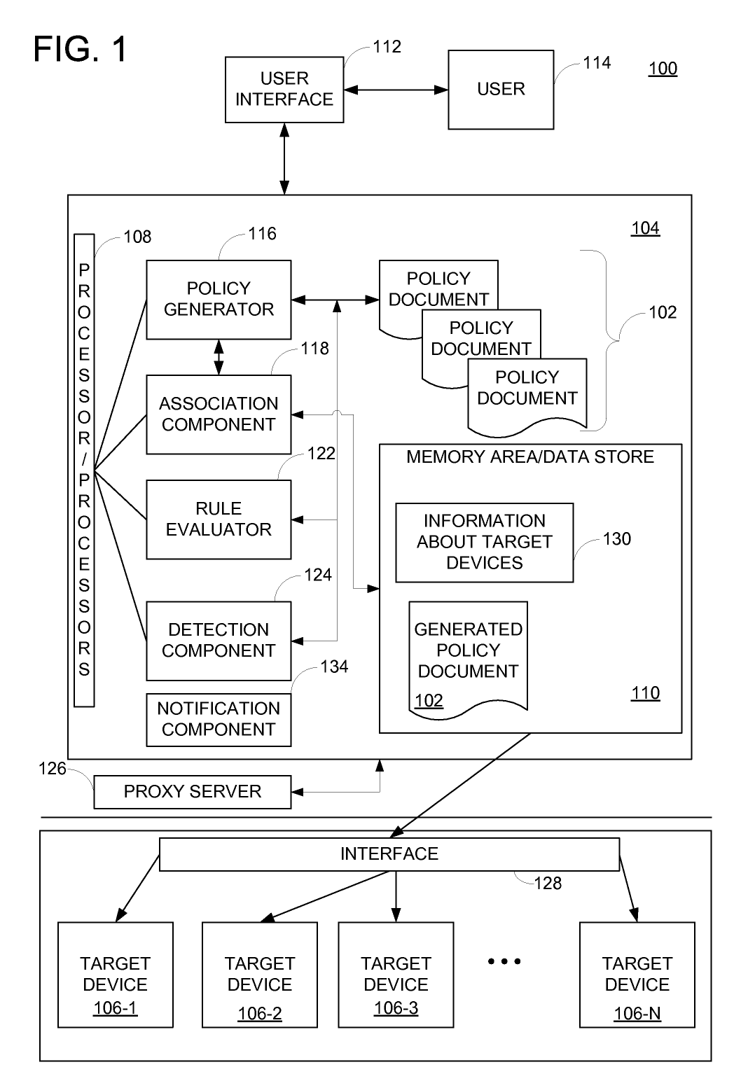

Referring now to FIG. 1, a block diagram illustrates a system 100 for managing configurations for software using a policy document 102 installed on target devices in a distributed computer network according to an embodiment of the invention. The system 100 includes a policy authority 104 for providing services to one or more target devices 106. The policy authority 104 may be a computer, a server computer, a computing device, a cluster of computers, a cluster of computing devices, or a cluster of processing units, such as a processing unit or a processor 108. For the sake of simplicity and without limitation, the policy authority 104 illustrated below is embodied in a server. It is to be understood that the policy authority may be implemented or embodied in other managed devices, such as target devices 106, without departing from the scope of the invention. The policy authority 104 is also associated with or coupled to a memory area or a data store 110. For example, the data store 110 may include a database, a memory storage area, and/or a collection of memory storage units. In an alternative embodiment, the data store 110 is connected by various networking means, such as a wired network connection or a wireless network connection. In another example, communication media, such as a wired network or direct-wired connection, and wireless media, such as acoustic, RF, infrared, and other wireless media, typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

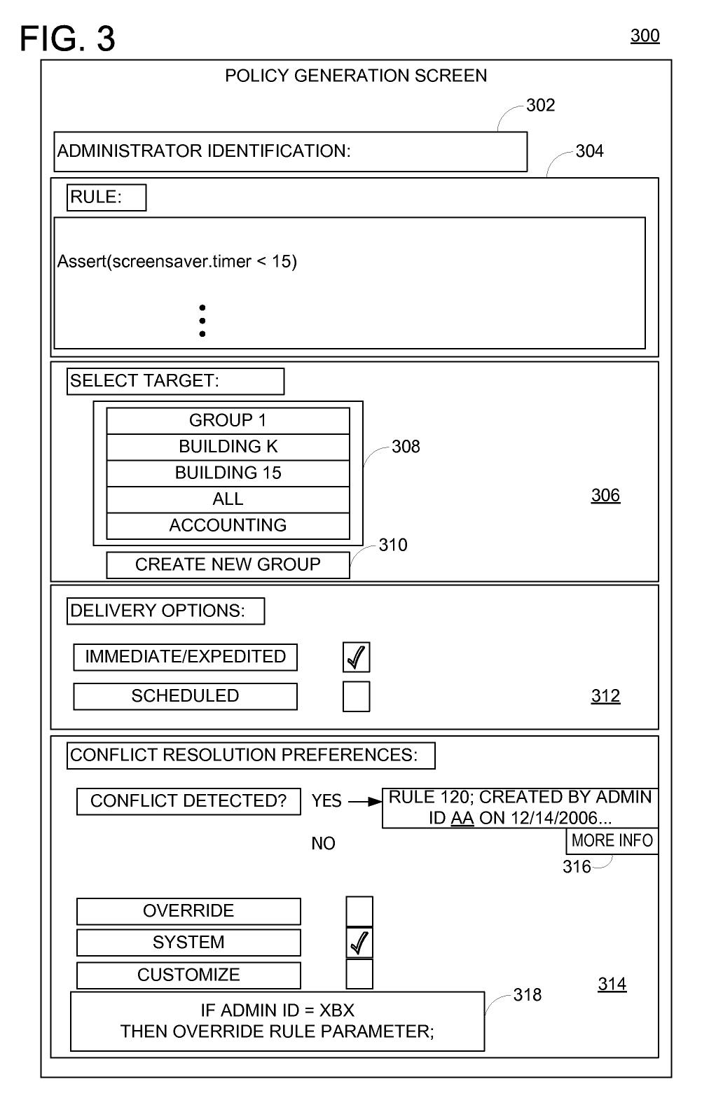

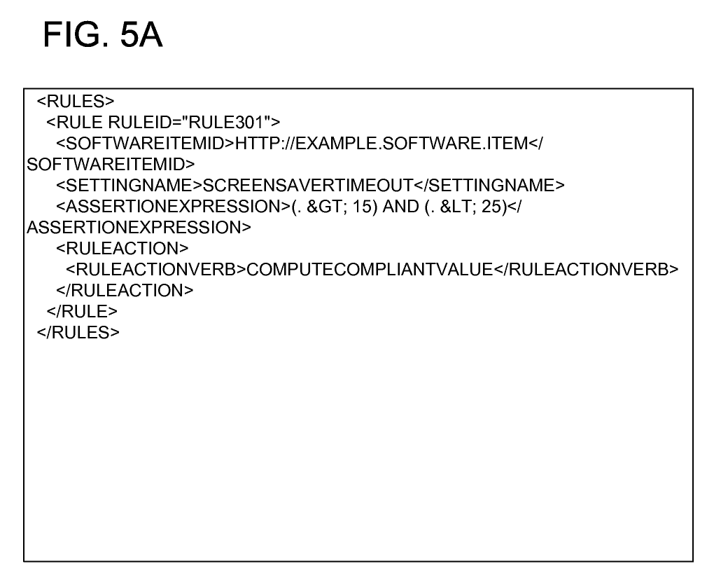

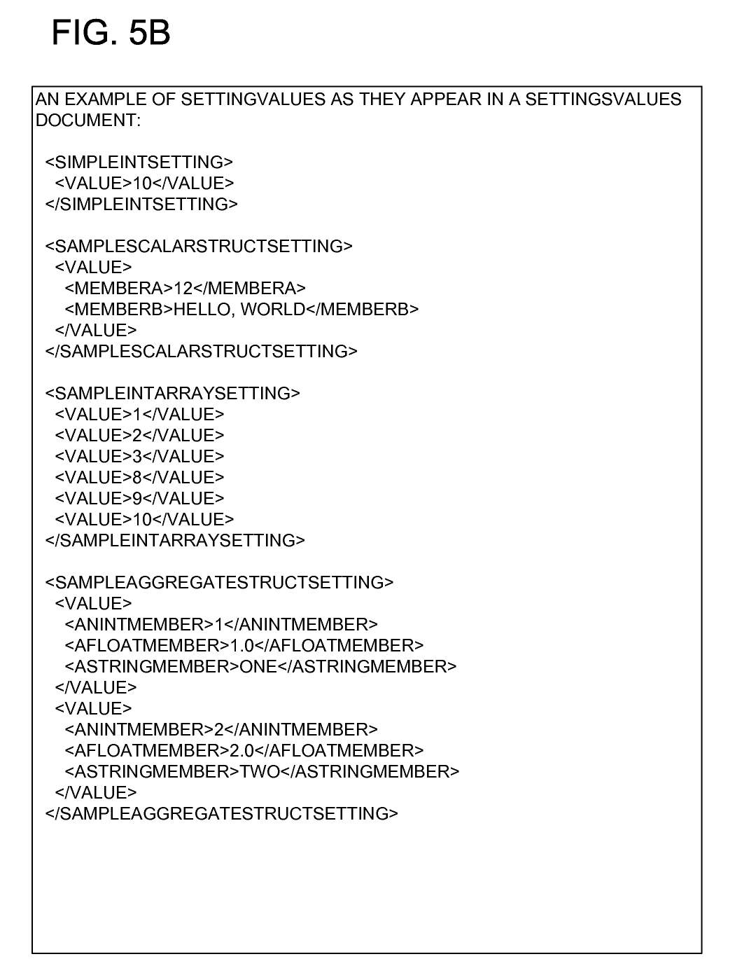

Aspects of the invention may be illustrated by using FIG. 3 as a starting point. FIG. 3 illustrates an exemplary graphical screen shot 300 illustrating a policy generation user interface (e.g., user interface 112) according to an embodiment of the invention. It is to be understood that the content of the graphical screen shot 300 may be represented by other means, such as a script-based or text-based interface. The graphical screen shot 300 includes a field 302 for administrator identification input. For example, an administrator may enter his or her name in the field 302 to identify who is creating the policy document 102. The graphical screen shot 300 also includes a field 304 for details about policy rules. Using the simplistic example of setting screen saver time period above, a user 114 may define a set of policy rules for software. In one embodiment, software includes an application, such as a screen saver program, a collection of applications or components of applications, an operating system, or the like in the field 304. The rule may be complex with operators, operands, and other values for defining a set of policy rules. In an alternative embodiment, the user 114 may use one or more defined data types for describing data to be included in the policy document 102 as shown in Appendix A, one or more exemplary operators on scalar types used in the policy rules definition appearing in the policy document illustrated in Appendix B, one or more exemplary operators on aggregate types used in the definition of policy rules in Appendix C, and one or more exemplary action types in Appendix D. In another alternative embodiment, the user 114 may compose the rule in XML format or other format or schema such that the policy rules may be executed and evaluated by the policy authority 104. Other format or schema for creating or defining executable expressions for universal application to various software may be used without departing from the scope of the invention. For example, FIG. 5A illustrates a relatively simplistic example of the policy document in XML according to an embodiment of the invention.

Referring further to the example of FIG. 3, the graphical screen shot 300 also includes a target selection section 306 in which the user 114 may define or select a set of target devices. For example, as shown in an existing selection 308, the following target group is available: “Group 1,” “Building K,” “Building 15,” “All,” and “Accounting.” Each of the groups defines its membership information of the target devices. For example, “Group 1” may include target devices associated with the IT management, while “Accounting” group may include all target devices in the accounting department. In an alternative embodiment, the graphical screen shot 300 may include additional operations to provide additional information relating to each member in a group or each group. For instance, the user 114 may use the right button on a common mouse input device to see additional details about each group or each member within a group. In a further embodiment, the graphical screen shot 300 includes a button 310 to enable the user 114 to create additional group for the target devices 106.

The graphical screen shot 300 also includes one or more delivery options in a field 312. For example, the user 114 may select an immediate or expedited delivery of the policy document to the set of selected target devices or a scheduled delivery of the policy document to the set of selected target devices. In one embodiment, when the immediate or expedited delivery option is selected, a notification may be issued to the set of selected target devices indicating that the policy document is to be retrieved. In the embodiment when a scheduled delivery is selected, the policy authority 104 may provide the policy document 102 via an interface 128 or temporarily store the policy document 102 in a content distribution data store to be retrieved at a scheduled time period and after the conflict resolution. Other delivery options may be provided without departing from the scope of the invention.

The graphical screen shot 300 includes a set of conflict resolution preferences 314 in which the user 114 may set preferences to resolve conflicts between to policy rules. For example, suppose an IT management staff member attempts to set a rule to activate the screen saver program after a 15-minute idle time period, while another IT management staff member attempts to set a rule to active the screen saver program after 10 minutes of idle time. Under existing technologies, these rules are executed as defined without either staff member knowing there was a conflict. Embodiments of the invention enable a federated conflict detection/resolution and provide both conflict detection and conflict resolution, as illustrated in section 314. For example, FIG. 3 illustrates that the policy authority 104 or components of the policy authority 104 detected a conflict between the created policy document and an existing rule “Rule 120” created by an administrator with an ID “AA” on Dec. 14, 2006. The user 114 may obtain additional or further information by click a button 316.

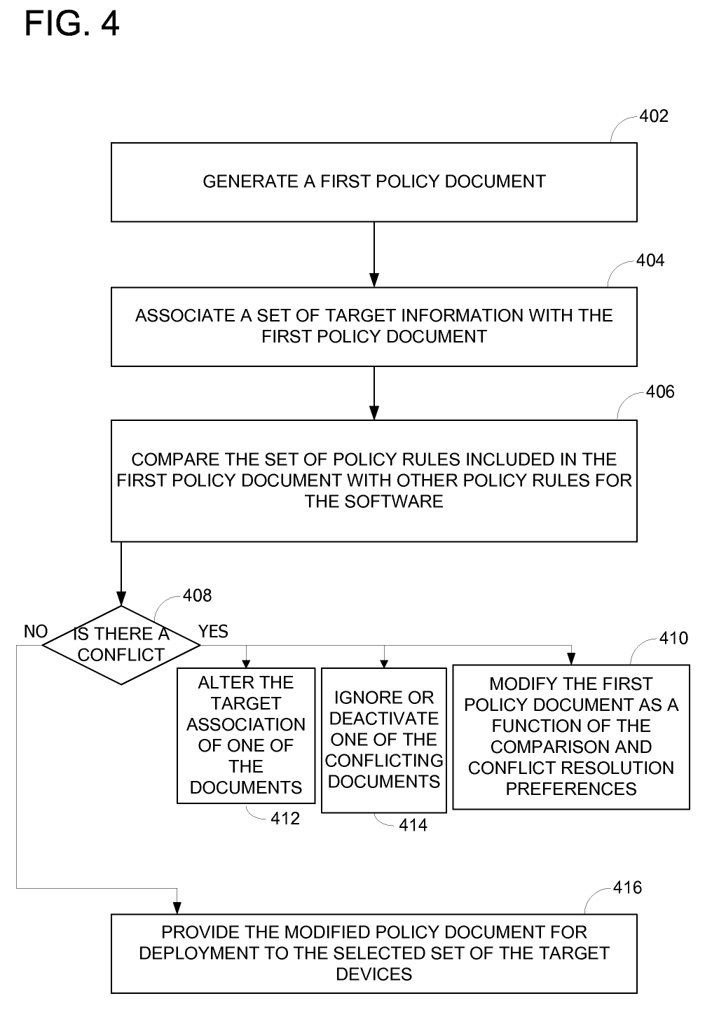

The user 114 may also select one or more exemplary conflict resolution preferences as listed in section 314: overriding the previously created rule, yielding to the previously created rule, or executing a customized rule. It is to be understood that other options to resolve conflict may be available without departing from the scope of the invention. For example, FIG. 4 describes other conflict resolution preferences and will be described in further detail below. A box 318 provides an input field for the user 114 to define the customized rule to resolve conflicts. As such, aspects of the invention provide automatic conflict detection when policies are assigned to targets and enable administrators to know as soon as possible when their newly assigned policy conflicts with an existing one. In addition, administrators will have some flexibility in determining if and how conflicts are automatically resolved by the system or arbitrarily according to the user 114. Moreover, embodiments of the invention may establish an execution order or hierarchy for the one or more policy rules.

It is also to be understood that, while the graphical screen shot 300 in FIG. 3 illustrates one or more selectable operations for using embodiments of the invention, other means of expressing the operations discussed above may be used. For example, a free-form template may be used in which the operations are to be selected and corresponding tags are automatically inserted in a draft policy document in real time after the operations are selected. In this example, the user 114 may select (e.g., using an input device) any operations, such as “Select Target,” and the corresponding tags may be inserted in to a draft policy document in real time. In a further alternative embodiment, drop-down-menus or other dynamic GUI techniques may be employed to further the generation of the policy document according to an embodiment of the invention.

Referring again to FIG. 1 and as illustrated above in FIG. 3, the policy document 102 is generated in response to instructions and preferences of the user 114. In one example, a collection of the policy document may be provided to the policy authority 104 via automated means, such as in a batch. In another embodiment, the graphical screen shot 300 shown in FIG. 3 is provided by a policy generator 116 which receives instructions or input from the user 114 to generate the policy document. An association component 118 associates a selected set of target devices 106 with the policy document 102 based on the instructions from the user 114. The association component 118 also associates a set of target information 130 with the policy document 102. In one embodiment, the information about the selected set of target devices include information about the application installed on the target devices and information relating to characteristics of each application of the selected set of target devices. For example, the information may include whether the application is based on legacy system, or the like.

Once the selected set of target devices 106 is associated with the policy document 102, a rule evaluator 122 compares the set of policy rules included in the policy document 102 with other policy rules for the software with respect to the target devices. For example and again referring to FIG. 3, the rule evaluator 122 compares the policy document 102 with existing or pending policy documents yet to be applied to the selected set of target devices. For example, the rule evaluator 122 compares the policy document 102 with the existing or pending policy documents created by a second instruction (e.g., from a user or pre-configured in an operating system, policy authority 104, client 106 or other automated sources). In another embodiment, a detection component 124 scans the content of the policy documents and compares the policy rules in each of the policy documents to determine whether there is a conflict between two policy rules within the policy document. In another alternative embodiment, the policy document 102 may be modified, either by the user 114 or by components of the policy authority 104, to resolve the conflict. For example, FIG. 3 discusses at least one method of resolving conflicts based on the conflict resolution preferences.

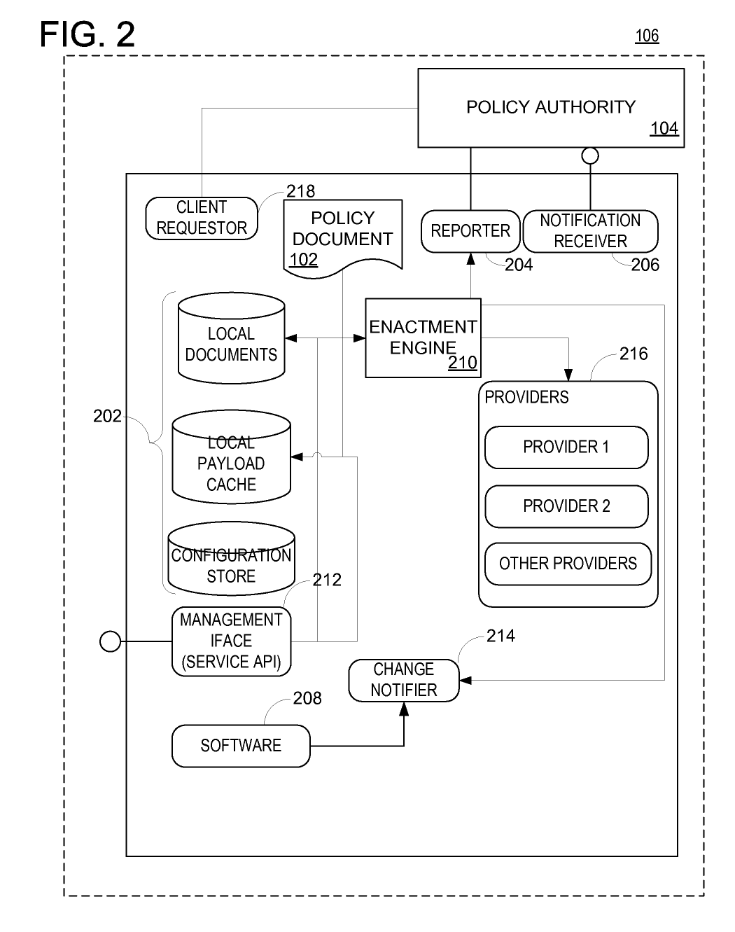

Once the policy document 102 is validated, the policy document 102 is compared by the rule evaluator 122, the policy document 102 is made available by the policy authority 104 to the selected set of target devices 106. An interface 126 receives the policy document 102 from the policy authority 104 and the selected set of target devices 106 may retrieve the policy document 102 from the policy authority 104 via the interface 126 or received a notification first before retrieving the policy document 102. In one embodiment, the interface 126 may be stateless, such as acting as a gateway between the policy authority 104 and the target devices 106, and does not store the policy document 102. For example, the policy authority 104 includes a notification component 134 for transmitting the notification to the target devices. In yet another embodiment, the policy authority 104 may include a proxy server 126 for performing part of the operations for notifying the selected set of target devices 106 (to be discussed further in FIG. 2). In yet another alternative embodiment, the policy generator 116, the association component 118, the rule evaluator 122, and the detection component 124 are computer-executable components embodied in one or more computer-readable media.

Referring now to FIG. 2, a block diagram illustrates exemplary components associated with the target device 106 according to an embodiment of the invention. The target device 106 includes a collection of local memory area 202, which includes storage area for storing the policy document 102 transmitted from the policy authority 104, cache of the policy document, and a data store storing configuration settings (e.g., a configuration store). The target device 106 also includes a notification receiver 206 or a listener for periodically monitoring a notification or availability of the policy document from the policy authority. In one example, the notification receiver 206 may contact the policy authority at a predetermined time, for example, every 10 days or the like, for the policy document 102. In the instance described above in FIG. 3 when an immediate delivery is requested, the notification receiver 206 may monitor the policy authority periodically for the policy document 102. Once the policy document 102 is available for the target device 106, the policy document 102 is stored locally on the memory area 202 associated with the target device 106. In one embodiment, the target device 106 may establish a first connection with the policy authority 104 when retrieving the policy document from the policy authority 104 and may terminate the first connection after completing the policy document 102 retrieval.

Once the policy document 102 is stored locally on the target device 106, the target device 106 evaluates the policy rules based on the software states of software 208. For example, configurations includes settings, configurable parameters, such as screen saver timer value or value for “enabling word wrap” for a text editing software. In another example, data for software state is stored in various forms in various local memory or data storage areas. These settings state may include state that is a configurable parameter, or other state like the last window size and position of an application window. For simplicity, all forms of such storage are depicted as a single configuration store (e.g., memory area 202). As such, the target device 106 reviews or examines the policy rules with the current software state to determine whether the software 208 complies with the rules defined in the policy document 102. In an alternative embodiment, one or more providers 216 (to be discussed in further details below) are used to retrieve and set current software state from the memory area 202.”

An alternative embodiment of the invention includes an enactment engine 210 for applying the policy rules included in the policy document to the software 208 on the target device 106. For example, the enactment engine 210 includes one or more computer-executable components for processing the policy rules. In one example, FIG. 5B illustrates an exemplary document generated on a managed target device as part of the enactment of policies by the enactment engine 210 on the target device according to an embodiment of the invention. In another embodiment, a management interface 212 exposes or provides an application programming interface (API) for the enactment engine 210 to be used by the user 114 to create locally policy documents for the managed target device. As such, the target device 106 may receive the policies from the policy authority 104 or the target device 106 may receive the policies from the user 114 of the target device 106. All policies retrieved are stored in the memory area 202 regardless of the source.

In a further embodiment, the target device 106 also includes a reporter 204 for reporting to the policy authority 104 or the proxy server 126 information associated with the status of the implementation or application of policy rules included in the policy document 102. Embodiments of the invention overcome shortcomings of existing technologies by establishing a common reporting system enabling an easy auditing of the compliance status (e.g., via a change notifier 214) of the software installed on the target device 106 within a distributed computer network.

Alternatively, embodiments of the invention enable the target device 106 to include a provider 216 for properly applying the configuration to the software 208. For example, the provider 216 reviews the policy rules in the policy document 102 and determines where the configurations for the software 208 are located. As such, the provider 216 determines, in order to make the software 208 comply with the policy rules in the policy document 102, which part of the software 208 is to be configured. The provider 216 next prepares the determined information, such as configuration parameter locations, and convert the information to a document with the configuration values in XML format or other executable expression formats. In another embodiment, the providers 216 may act as an interface or intermediary between the enactment engine 210 and the memory area 202, and may translate data in the memory area 202 to and from the common form according to the schema of the invention.

In another embodiment, the target device 106 may include a mobile device or a portable (not shown) and the proxy server 126 in FIG. 1 may perform portions or parts of the operations described above in FIG. 2. For example, due to the processing and/or memory limitation of the portable or mobile device, the proxy server 126 may request the policy document 102 for the portable or mobile device. The proxy server 126 retrieves the policy document 102 on behalf of the portable or mobile device and the enactment engine on the portable or mobile device executes the policy rules. The reporter 204 reports the status of how the current state of the software matches the state specified by the policy authority 102. In yet another aspect of the invention, the target device 106 may include a client requester 218 for actively requesting the policy document from the policy authority 104.

In one other aspect of the invention, the reporter 204, the notification receiver 206, the enactment engine 210, the management 212, the setting providers 214, the change notifier 216, or the client requester 218 may be embodied in one or more computer-readable media as computer-executable components coupled to the target device 106. In a further embodiment, the policy authority 104 may be physically embodied with the client 106 on the same hardware or may be co-resident on the same hardware with the client 106 (as illustrated by the broken lines in FIG. 2). An implementation of the policy authority 104 may exist on either a server or a managed device and is generally, but not limited to, where all policy authoring takes place. In another embodiment, the target device 106 is generally, but not limited to, where policy consumption takes place.

Referring now to FIG. 4, an exemplary flow chart illustrates operation of managing configurations for software installed on target devices according to an embodiment of the invention. For example, the policy authority 104 and/or various components (e.g., policy generator 116, association component 118, rule evaluator 122, detection component 124, and/or notification component 134) perform one of the operations described in FIG. 4. At 402, a first policy document is created. The first policy document (e.g., the policy document 102) includes a set of policy rules defining the desired configuration of one or more pieces of software on the target device. The set of target information is associated with the first policy document, and the set of target information corresponds to a selected set of the target devices and includes information relating to characteristics of each software of the selected set of target devices at 404. At 406, the set of policy rules included in the first policy document is compared with other policy rules for the software. For example, if it is determined at 408 that there is a conflict between the first policy document and another policy document, the first policy document is modified as a function of the comparison and conflict resolution preferences at 410.

In another embodiment, other preferences or options, such as altering the target association of one of the documents at 412 or ignoring or deactivating one of the conflicting documents at 414 may be chosen for resolving the conflict. The conflict resolution preferences include factors to determine which policy document to be provided to the software. The modified policy document is provided to the selected set of target devices at 416. If, on the other hand, there is no conflict as determined at 408, the first policy document is provided for deployment to the selected set of the target devices.

In operation, a computer such as the policy authority 104 executes computer-executable instructions such as those illustrated in the figures (e.g., FIG. 1) may be employed to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### APPENDIX A

For illustration purposes only and not by limitation, the following table lists one or more scalar types used according to an embodiment of the invention.

Type

64-bit long integer, signed and unsigned
32-bit integer, signed and unsigned
8-bit unsigned byte sequence (aka “binary blob”)
UTF-8 string
URI
Enumeration
Boolean
Double (In one example, floating point type may be used to accommodate
at least xs:float-sized data and xs:double-sized data.)
Datetime
Document reference
Struct

### APPENDIX B

For illustration purposes only and not by limitation, in the below table, P represents the value of a property variable (a Setting Value), v represents a scalar literal value, and V represents an aggregate literal value:

| Operator | Semantics | Notes |
|---|---|---|
| Equality: P == v where P | Returns true if P and v are | In one embodiment, string |
| and v are of compatible type | considered equal. | equality (e.g., lexical or literal), |
| | Aggregate equality is that | case-insensitive comparison |
| | both arrays are the same | for strings, whitespace- |
| | length and P[i] == v[i] for all | insensitive comparison for |
| | i in P. Given that aggregates | strings, “comparison |
| | are unique and unordered, | semantics” for string types, |
| | aggregate quality is the same | conflict detection (e.g., P == V, |
| | as “P contains exactly the | P == Y conflicts) and other |
| | elements of v.” | features may be included. |
| Inequality: P != v where P | Returns not (P == v) | Conflict Detection/Examples: |
| and v are of compatible type | | P == V, P!=V Conflicts |
| | | P = {On, Off} |
| | | P!=On, P!=Off Conflicts |
| Less than: P < v | Returns true if P is less than | Same comments for equality |
| | v. | of string types. |
| | Not defined for aggregates | Conflict Detection/Examples: |
| | or structs (See note 1.) | Example 1: |
| | | P < 10, A = 9 |
| | | P < 5, A = 4 - conflicts |
| | | Example 2: |
| | | P < 10, A = 3 |
| | | P < 5, A = 4 - does not |
| | | conflict |
| Less than or equal: P <= v | Returns (P < v) or (P == v) | Conflict Detection/Examples: |
| | Not defined for aggregates | Similar to above |
| | or structs (See note 1.) | |
| Greater than: P > v | Returns not (P <= v) | Conflict Detection/Examples: |
| | Not defined for aggregates | Similar to above |
| | or structs (See note 1.) | |
| Greater than or equal to: P >= v | Returns (not (P < v)) or (P | Conflict Detection/Examples: |
| | == v) | Similar to above |
| | Not defined for aggregates | |
| | or structs (See note 1). | |
| Contains: P.contains(v) | Returns true if P.count > 0 | Strings are not aggregates. To |
| where P is an aggregate type | and there exists at least one | get “string P contains a |
| and v is a compatible scalar | value of i for which P[i] == | substring v,” use the matches( ) |
| type | v. | operator. |
| | | Conflict Detection/Examples: |
| | | Straight forward |
| Contains: P.contains(V) | Returns true if (v = V[i]; | Strings are not aggregates. |
| where P is an aggregate type | P.contains(v)) for every i in | Conflict Detection/Examples: |
| and v is a compatible | V | Straight forward and does not |
| aggregate type. | | depend on the ordering of the |
| | | v. Identical to specifying P |
| | | contains(v1) and P contains |
| | | (v2) and P contains (v3) where |
| | | V = {v1, v2, v3} |
| Matches: P.matches(p) | Returns true if the regular | Regex pattern is that which is |
| where p is a regex pattern | expression evaluator | specified in the XML Schema |
| and P is a string | indicates that P matches the | spec. |
| | expression p. | (See Note 4) |
| | (See Note 5) | |
| Is One Of: P.isOneOf(V) | Returns true if there exists at | (See note 3) |
| where P is a scalar type and | least one value of i for which | |
| v is an aggregate of a | P == V[i] for all i in V. | |
| compatible type | This is the same as | |
| | V.contains(P) | |
| Aggregate count: P.count( ) | Returns true is the number of | |
| op v, where P is an | values in P meets the criteria | |
| aggregate type, op is one of | stipulated. | |
| {equals, less than, less than | | |
| or equal to, greater than, | | |
| greater than or equal to}, | | |
| and v is an integer value | | |
| Logical negation: not expr | Returns true if expr is false, | |
| | false if expr is true. | |
| Logical and: expr1 and | Returns true if expr1 is true | If expr1 is false, then expr2 |
| expr2 | and expr is also true, false | may not be evaluated. |
| | otherwise. | |
| Logical or: expr1 or expr2 | Returns true if either expr1 | If expr1 is true, then expr2 |
| | or expr2 is true, false | may not be evaluated. |
| | otherwise | |

1. In one embodiment, an aggregation may be established using P.count==v.count and P[i]<v[i] for all i in P.

2. Expressions are evaluated left-to-right, and in an alternative embodiment, some or all of expressions may not be evaluated in a policy document.

3. IsOneOf may allow restriction of values to a degree even finer than possible by that of an enumeration. For example, the developer may define the enumeration as “Low, Medium, High, Very High,” but the allowed values per the admin intent are “Low and Medium.” Therefore, the administrator's policy is expressed as an assertion like P.IsOneOf({Low, Medium}. Note that IsOneOf may be used with other scalar types than enums. For instance, the developer may say that the setting is an int between 0 and 100, but the admin can use IsOneOf to restrict the setting to, say, 10, 42, 50, and 85.

4. In one alternative embodiment, the conflict detection may be employed as a static analysis of assertion expressions.

5. An aggregate Matches( ) operator may be defined for aggregates of scalar string types by saying that all elements of the aggregate must match the pattern.

### APPENDIX C

In an alternative embodiment, the following table provides for illustrations purposes only and not by limitation, exemplary operators on aggregate types used in the definition of policy rules may be represented as below:

Operator

Equality: P == v where P and v are of compatible type
Inequality: P != v where P and v are of compatible type
Less than: P < v
Less than or equal: P <= v
Greater than: P > v
Greater than or equal to: P >= v
Contains: P.contains(v) where P is an aggregate type and v is a
compatible scalar type
Contains: P.contains(V) where P is an aggregate type and v is a
compatible aggregate type.
Matches: P.matches(p) where p is a regex pattern and P is a string
Is One Of: P.isOneOf(V) where P is a scalar type and v is an aggregate
of a compatible type
Aggregate count: P.count( ) op v, where P is an aggregate type, op is
one of {equals, less than, less than or equal to, greater than, greater
than or equal to}, and v is an integer value
Logical negation: not expr
Logical and: expr1 and expr2
Logical or: expr1 or expr2
Replace existing value (scalar)
Replace existing value (aggregate)
Merge scalar w/ existing aggregate value
Merge aggregate w/ existing aggregate value
Remove existing scalar value from aggregate value (aggregate only) (if
ACL contains group1, remove group1)
Remove existing values from aggregate value (set difference)
Compute compliant value

### APPENDIX D

For illustrations purposes only and not by limitations, exemplary actions to be included in a policy document are described below according to an embodiment of the invention:

| Action | Semantics | Description |
|---|---|---|
| No-op | Does nothing | used to report compliance |
| | | failure |
| Replace existing value | P = v | If P has no prior value (it is |
| (scalar) | Postconditions: | not set), then the new value |
| | P.equals(v) is true | of P is v. If P has a prior |
| | | value (it is set), then the new |
| | | value is v. |
| Replace existing value | P = v | If P has no prior value (it is |
| (aggregate) | Postcondition: | not set), then the new value |
| | P.equals(v) is true | of P is v. If P has a prior |
| | P[i] == v[i] for all i in v | value (it is set), then the new |
| | P.count == v.count | value is v. |
| | | Elements are added or |
| | | removed from P such that P |
| | | and v have the same length. |
| Merge scalar w/ existing | If P.contains(v), then do | As aggregates are unordered, |
| aggregate value | nothing, else add v as a new | “where” in the aggregate the |
| | element of P | new elements are added is |
| | Postcondition: | not defined or significant. |
| | P.contains(v) is true | |
| | Pnew.count = Pold.count + | |
| | (Pold.contains(v) ? 0 : 1) | |
| | P is an aggregate, v is scalar | |
| Merge aggregate w/ existing | Same as in scalar merge for | |
| aggregate value | all v = V[i] for all i in V | |
| Remove existing scalar value | P = P − v | |
| from aggregate value | If not P.contains(v) then do | |
| (aggregate only) (if ACL | nothing, else find the element | |
| contains group1, remove | p = P[i] where p == v, and | |
| group1) | remove it. | |
| | Postcondition: | |
| | P.contains(v) is false | |
| | Pnew.count = Pold.count − | |
| | (Pold.contains(v) ? 1 : 0) | |
| Remove existing values from | P = P − V | |
| aggregate value (set | Same as in scalar remove for | |
| difference) | all v = V[i] for all i in V | |

What is claimed is:

1. A computerized method for managing software states using policy rules, said policy rules being applied to one or more pieces of software installed on one or more target devices, said computerized method comprising:
generating a first policy document, said first policy document including a set of policy rules defining one or more desired configurations of the one or more pieces of software on the target devices;
associating a set of target information with the first policy document, said set of target information corresponding to a selected set of the target devices and including information relating to characteristics of the software of the selected set of target devices;
comparing the set of policy rules included in the first policy document with other policy rules for the software;
modifying the first policy document as a function of the comparison and conflict resolution preferences; and
providing the modified policy document for deployment to the selected set of the target devices.

2. The computerized method of claim 1, further comprising receiving a report from the set of the one or more target devices, said report indicating a result of applying the modified policy document or the generated policy document on the software installed on the one or more target devices.

3. The computerized method of claim 1, wherein evaluating the generated policy document comprises detecting a conflict between the first policy document generated based upon the first instruction and a second policy document generated based upon a second instruction.

4. The computerized method of claim 3, wherein evaluating comprises evaluating the detected conflict based upon at least a time period when the first policy document and the second policy document were created.

5. The computerized method of claim 4, wherein modifying comprises generating a valid set of policy rules based on the evaluated conflict detected between the first and second policy documents.

6. The computerized method of claim 1, wherein evaluating the first policy document comprises evaluating the first policy document by comparing the set of policy rules included in the generated first policy document with other policy rules for the software installed on the set of one or more target devices.

7. The computerized method of claim 1, wherein one or more computer-readable media have computer-executable instructions for performing the computerized method of claim 1.

8. A system for managing policy rules in a distributed network environment, said system comprising:
a first user interface for receiving instructions from a user, said first instructions including definition for policy rules;
a processing unit configured to execute computer-executable instructions for:
generating a policy document including a set of policy rules in response to instruction received from the user, said set of policy rules defining one or more desired configurations of one or more pieces of software on the target devices;
associating target information with the policy document, said target information corresponding to a selected set of target devices and including information relating to characteristics of the software of the selected set of target devices; and
comparing the set of policy rules included in the generated policy document with other policy rules for the software;
a memory area for storing the generated policy document; and
a second interface for providing the policy document as a function of the comparison for deployment to the one or more target devices.

9. The system of claim 8, wherein the processing unit is further configured to execute one or more of the following computer-executable instructions:
detecting a conflict between the generated policy document and a second policy document generated based upon a second instruction; and
evaluating the detected conflict based upon conflict resolution preferences.

10. The system of claim 9, wherein the processor is configured to evaluate the detected conflict based upon at least a time period when the first policy document and the second policy document were created.

11. The system of claim 9, wherein the processing unit is further configured to generate a valid set of policy rules based on the evaluated conflict detected between the policy document and the second policy document.

12. The system of claim 11, wherein the processing unit is further configured to establish an execution order between the generated policy document and the second policy document based upon the evaluation.

13. The system of claim 9, wherein the processing unit is configured to evaluate the policy document by comparing the set of policy rules included in the generated policy document with other policy rules for the software installed on the one or more target devices.

14. The system of claim 8, wherein the second interface is configured to transmit a notification to the one or more target devices indicating the generated policy document or the modified policy document is available for deployment, and wherein the second interface is configured to receive a response from the one or more target devices in response to the notification.

15. One or more computer-readable storage media having computer-executable components for deploying configurations to software, said computer-executable components comprising:
a user interface for receiving instructions from a user;
a policy generator for generating a policy document including a set of policy rules in response to instruction received from the user, said set of policy rules defining one or more desired configurations of one or more pieces of software on the target devices;
an association component for associating target information with the policy document, said target information corresponding to a selected set of the target devices;
a rule evaluator for comparing the set of policy rules included in the generated policy document with other policy rules for the software with respect to the target devices;
a data store for storing the generated policy; and
wherein said user interface provides a result of the comparison by the rule evaluator.

16. The computer-readable storage media of claim 15, further comprising:
a detection component for detecting a conflict between the policy document generated based upon the instruction and a second policy document generated based upon a second instruction; and wherein the rule evaluator evaluates the detected conflict based upon conflict resolution preferences.

17. The computer-readable storage media of claim 16, wherein the rule evaluator is further configured to generate a valid set of policy rules based on the evaluated conflict detected between the policy document and the second policy document.

18. The computer-readable media of claim 15, wherein the association component further comprising establishing an execution order between the generated policy document and the second policy document based upon the evaluation.

19. The computer-readable media of claim 15, wherein the rule evaluator comprises comparing the set of policy rules included in the generated policy document with other policy rules for the software installed on the one or more target devices.

20. The computer-readable media of claim 15, further comprising a notification component for transmitting a notification to the one or more target devices indicating the generated policy document or the modified policy document is available for deployment.
